(19) United States
(12) Patent Application Publication
(10) Pub. No.: US 2019/0315655 A1
(43) Pub. Date: Oct. 17, 2019

(54) METHOD FOR REDUCING BITUMEN AND CRMB ODORS

(71) Applicant: SHELL OIL COMPANY, HOUSTON, TX (US)

(72) Inventors: Jacques COLANGE, Colombes Cedex (FR); Liting XU, Shanghai (CN); Hui YAN, Beijing (CN)

(21) Appl. No.: 16/340,726

(22) PCT Filed: Oct. 11, 2017
(86) PCT No.: PCT/CN2017/105711

§ 371 Date: Apr. 10, 2019

(30) Foreign Application Priority Data
Oct. 12, 2016 (CN) PCT/CN2016/101906

(51) Int. Cl. C04B 24/04; C04B 26/26; C04B 18/22; C04B 24/36

(52) U.S. Cl. CPC C04B 24/045; C04B 26/26; C04B 2111/0075; C04B 24/36; C04B 18/22

(57) ABSTRACT

Provided is a method for reducing odors including the steps of admixing active agents and a diluting agent to liquid bitumen or to liquid crumb rubber modified bitumen. The active agents comprise 20 to 60 wt.-% of an aldehyde selected from alpha-hexyl cinnamaldehyde, 2-(4-tert.-butylbenzyl) propionaldehyde, 2-benzylidenheptanal, or mixtures thereof, 10 to 40 wt.-% of one or more alcohols having boiling point of at least 150° C., and 0.3 to 1 wt.-% compound selected from a compound comprising 10 carbon atoms and an hydroxyl functional group, an ester of a compound comprising 10 carbon atoms and an hydroxyl functional group, or mixtures thereof, calculated on the total weight of active agents. The bitumen and/or crumb rubber modified bitumen obtained according to the method, and the use thereof are also provided.

### FIELD OF THE INVENTION

The invention relates to a method for reducing odors in compositions comprising bitumen and/or crumb rubber modified bitumen. The odors are reduced by admixing active agents.

### BACKGROUND TO THE INVENTION

Bitumen is a viscous liquid or a solid consisting essentially of hydrocarbons and their derivatives. It is soluble in trichloroethylene and softens gradually when heated.

Bitumen is used on an industrial scale, e.g. in road surfacing and road base materials, in insulating layers for buildings, in sealing sheeting, and in roofing materials such as roofing membranes, felts and shingles. Especially when used to pave roads or other surfaces, bitumen may be combined with mineral aggregate to form asphalt concrete. Mineral aggregate may comprise sand, gravel, (crushed) stones, slag, recycled concrete and/or geosynthetic aggregates. In one method to prepare asphalt concrete, mineral aggregate and crumb rubber are combined, and then bitumen is added during the asphalt production process.

Crumb rubber, also referred to as Ground Tire Rubber, comprises particles of rubber which are typically obtained from used vehicle tires. Such material can be incorporated into bitumen. This is a sustainable means of reducing the number of tires which are disposed of. The crumb rubber can also improve the properties of the bitumen.

Crumb rubber can be mixed with or mechanically dispersed in bitumen, after which it may be used on an industrial scale. Bitumen comprising crumb rubber may also be referred to as Crumb Rubber Modified Bitumen (CRMB).

In many applications, bitumen or CRMB is processed in softened or in liquefied form. At the processing temperatures, which are above 100° C., often above 140° C. or even as high as 200° C., volatile substances present in bitumen or CRMB may be released to the air. Especially sulfur and nitrogen compounds may lead to foul odors.

EP2185640B1 (AU2008285878B2) describes a method for reducing bitumen odors. Active agents and a diluting agent are admixed to liquid bitumen.

There is a need for an improved method.

### SUMMARY OF THE INVENTION

It has now been found that the method described in EP2185640B1 can be improved by making use of one or more specific compounds. It has been found that this improved method is very suitable to be used for bitumen, as well as for bitumen that is crumb rubber modified.

The present invention relates to a method for reducing odors including the steps of admixing active agents and a diluting agent to liquid bitumen or to liquid crumb rubber modified bitumen wherein the active agents comprise:
A: 20 to 60 wt.-% of aldehyde(s) selected from:
   A1. alpha-hexyl cinnamaldehyde,
   A2. 2-(4-tert.-butylbenzyl) propionaldehyde,
   A3. 2-benzylidenheptanal, or mixtures thereof,
B: 0 to 20 wt.-% of one or more other aldehydes having at least 10 carbon atoms in the molecule,
C: 10 to 40 wt.-% of one or more alcohols having a boiling point of at least 150° C.,
D: 0 to 20 wt.-% of one or more terpenes having a boiling point of at least 150° C.,
E: 0 to 10 wt.-% of ketone(s) having a boiling point of at least 150° C.,
F: 0.3 to 1 wt % of compound(s) selected from:
   F1. one or more compounds comprising 10 carbon atoms and an hydroxyl functional group,
   F2. one or more esters, the ester being an ester of a compound comprising 10 carbon atoms and an hydroxyl functional group, preferably an acetate or a propionate thereof,
   or mixtures thereof,
G: 0 to 10 wt.-% of carbonic acid ester(s), whereby the ester is different from component F;
calculated on the total weight of active agents.

The invention further relates to a bitumen or a CRMB composition as obtained by the method of the invention.

The invention also relates to the use of a bitumen or a CRMB composition as obtained by the invention in road surfacing and road base materials, in insulating layers for buildings, and in roofing materials such as roofing membranes, felts and shingles, and in sealing sheeting.

### DETAILED DESCRIPTION OF THE INVENTION

The present invention relates to a method for reducing odors including the steps of admixing active agents and a diluting agent to liquid bitumen or to liquid crumb rubber modified bitumen wherein the active agents comprise:
A: 20 to 60 wt.-% of aldehyde(s) selected from:
   A1. alpha-hexyl cinnamaldehyde,
   A2. 2-(4-tert.-butylbenzyl) propionaldehyde,
   A3. 2-benzylidenheptanal, or mixtures thereof,
B: 0 to 20 wt.-% of one or more other aldehydes having at least 10 carbon atoms in the molecule,
C: 10 to 40 wt.-% of one or more alcohols having a boiling point of at least 150° C.,
D: 0 to 20 wt.-% of one or more terpenes having a boiling point of at least 150° C.,
E: 0 to 10 wt.-% of ketone(s) having a boiling point of at least 150° C.,
F: 0.3 to 1 wt % of compound(s) selected from:
   F1. one or more compounds comprising 10 carbon atoms and an hydroxyl functional group,
   F2. one or more esters, the ester being an ester of a compound comprising 10 carbon atoms and an hydroxyl functional group, preferably an acetate or a propionate thereof,
   or mixtures thereof,
G: 0 to 10 wt.-% of carbonic acid ester(s), whereby the ester is different from component F;
calculated on the total weight of active agents.

The weight percentages of components A to G are calculated on the total weight of active agents. The active agents used comprise components A to G; other active agents may be present. Preferably the active agents used contain components A to G, whereby the weight percentages of components A to G add up to 100%.

Preferably a mixture of active agents and diluting agent is admixed to the liquid bitumen or the liquid CRMB. The steps of admixing active agents and diluting agent may thus be performed as a single step. The mixture preferably comprises 5 to 50 wt.-% active agents and 95 to 50 wt.-% of a diluting agent.

Preferably the mixture is admixed to liquid bitumen in amounts of from 10 to 200 ppm. This is preferably performed at temperatures above 140° C., in particular at temperatures between 150 and 250° C.

Preferably the mixture is admixed to liquid CRMB in amounts of from 50 to 400 ppm. This is preferably performed at temperatures above 140° C., in particular at temperatures between 150 and 250° C.

### Bitumen

The bitumen may be a residue from the distillation or other means of processing crude oil, naturally occurring bitumen or a blend of various bitumen types. Examples of bitumen that may be conveniently used include distillation or “straight run” bitumen, precipitation bitumen, e.g. propane bitumen, oxidized or blown bitumen, naphthenic bitumen or mixtures thereof. The bitumen may be prepared by blending bitumen with flux oil, e.g. aromatic, naphthenic or paraffinic flux oil. The bitumen can also be derived from a natural oil sand source or can contain components of renewable origin. The penetration at 25° C. of the bitumen (as measured according to EN 1426) is preferably between 10 and 250. If the bitumen is a blend of bitumen and flux oil, the penetration is preferably between 10 and 250 after the flux oil has been blended with the bitumen.

The bitumen preferably contains residues from crude oil distillation, or naturally occurring bitumen, or mixtures thereof, whereby the bitumen optionally comprises a polymer, preferably a thermoplastic elastomer or plastomer, more preferably a styrene block copolymer and/or an olefin copolymer, even more preferably ethylene/vinylacetate copolymer.

### Crumb Rubber Modified Bitumen

The crumb rubber modified bitumen used in the method of the invention preferably is a crumb rubber modified bitumen composition comprising:
(a) 20 to 97 wt % bitumen;
(b) 3 to 80 wt % of crumb rubber;
calculated on the total weight of the crumb rubber modified bitumen composition.

The crumb rubber modified bitumen used in the method of the invention may be a composition as described in WO2010023173. These CRMB compositions show high storage stability. The crumb rubber modified bitumen may comprise 20 to 96 wt % bitumen; 3 to 80 wt % of crumb rubber; 0.1 to 10 wt % of a polymer comprising glycidyl functional groups; and 0.3 to 5 wt % of a wax, calculated up the total weight of the CRMB composition.

The bitumen in the crumb rubber modified bitumen composition may be as described above.

The quantity of bitumen in the CRMB composition preferably is from 20 to 97 wt %, more preferably 20 to 96 wt %, even more preferably from 30 to 92 wt %.

The crumb rubber in the crumb rubber modified bitumen composition is any rubber in particle form. Preferably the crumb rubber is ground tire rubber. Preferably the mean average particle size is less than 5 mm, more preferably less than 2 mm and most preferably less than 1 mm. The crumb rubber may contain a synthetic elastomer such as polybutadiene or styrene-butadiene rubber, which may be obtained from tires of light vehicles. The crumb rubber may also be natural rubber, which may be obtained from tires of heavy vehicles.

The quantity of crumb rubber in the bitumen composition preferably is from 3 to 80 wt %, more preferably from 6 to 70 wt %.

In one embodiment the crumb rubber modified bitumen composition comprises 0.1 to 10 wt % of a polymer comprising glycidyl functional groups. The polymer comprising glycidyl functional groups is preferably either a copolymer wherein at least some of the monomers are glycidyl-containing monomers, or is a grafted polymer wherein glycidyl-containing groups have been grafted onto a polymer backbone as described in WO2010023173.

In one embodiment the polymer preferably is a copolymer of ethylene and glycidyl acrylate or methacrylate, or a terpolymer of ethylene, alkyl acrylate or methacrylate and glycidyl acrylate or methacrylate.

In another embodiment the polymer preferably is a grafted polymer comprising glycidyl acrylate or methacrylate grafted onto a polyethylene backbone.

In one embodiment the crumb rubber modified bitumen composition comprises 0.3 to 5 wt % of a wax. The wax in the bitumen composition is preferably a paraffin wax, and is more preferably a wax resulting from a Fischer-Tropsch process. Preferably the paraffin wax comprises at least 90 wt % of straight chain alkanes. Preferably the alkane chain length is from C₃₀ to about C₁₀₀. Preferably the melting point of the paraffin wax is from 50 to 110° C., more preferably from 80 to 110° C. Alternatively the wax is ethylene bis-stearamide.

### Diluting Agent

The invention relates to a method for reducing odors including the steps of admixing active agents and a diluting agent to liquid bitumen or liquid CRMB. The active agents and the diluting agent may be added separately. Preferably a mixture of the active agents and a diluting agent is admixed to the liquid bitumen or the liquid CRMB. Hence, preferably the invention relates to a method including the step of admixing a mixture of active agents and a diluting agent to liquid bitumen or liquid crumb rubber modified bitumen.

The mixture preferably contains 5 to 50, in particular 10 to 40, wt.-% active agents and 95 to 50, in particular 90 to 60, wt.-% diluting agent.

Preferred diluting agents include mineral oils, i.e. hydrocarbon middle distillates, such as base oil, as well as vegetable oils such as sunflower oil which consists mainly of linoleic acid. Preferably the diluting agent is a mineral oil, more preferably a hydrocarbon middle distillate, or a vegetable oil, more preferably sunflower oil, or a mixture thereof. Preferably the diluting agent is a mixture of base oil and sunflower oil, preferably sunflower oil with a high flash point.

### Active Agents

The aldehyde(s) of component A is/are selected from:
A1. alpha-hexyl cinnamaldehyde (jasmonal H),
A2. 2-(4-tert.-butylbenzyl)propionaldehyde (Lilial),
A3. 2-benzylidene heptanal (jasminal),
or mixtures thereof.

In a particularly preferred embodiment, component A contains all three of the aldehydes specified above.

The other optional aldehyde(s) of component B is/are preferably selected from:
B1. 3-(4-iso-propylphenyl)-2-methylpropanal (cyclamaldehyde), particularly in amounts of from 2 to 12 wt.-%,
B2. 2-methylundecanal, particularly in amounts of from 2 to 8 wt.-%,
B3. 2-methyl-3-(3,4-methylene-dioxyphenyl)propanal (helional), particularly in amounts of from 0.5 to 5 wt.-%, or mixtures thereof.

In a particularly preferred embodiment, component B contains all three of the aldehydes specified above. Moreover, the aldehydes listed in EP1235768A are also well-suited. The amounts of benzaldehyde and citral that are present should preferably be at most 5 wt.-%.

Preferably, naturally occurring alcohol(s) is/are used as component C. The alcohol(s) is/are preferably selected from:
C1. linalol having a boiling point of 198° C., particularly in amounts of from 5 to 25 wt.-%,
C2. eugenol having a boiling point of 253*C, particularly in amounts of from 3 to 12 wt.-%,
C3. geraniol having a boiling point of 230° C., particularly in amounts of from 3 to 12 wt.-%,
C4. alpha-terpineol having a boiling point of 219° C., particularly in amounts of from 0.5 to 5 wt.-%, or mixtures thereof.

In a particularly preferred embodiment, component C contains all four of the alcohols specified above. Other alcohols, such as vanillin and thymol, are also well-suited.

The optional terpene(s) of component D is/are preferably selected from:
D1. limonene having a boiling point of 176° C., particularly in amounts of from 0.5 to 5 wt.-%,
D2. alpha-pinene having a boiling point of 156° C., particularly in amounts of from 0.5 to 5 wt.-%, or mixtures thereof.

In a particularly preferred embodiment, component D contains both of the terpenes specified above. Terpenes that are present in natural essential oils as well as the terpenes listed in WO2004099352A are also well suited.

Well-suited as ketones in optional component E are e.g.: benzophenone, butyl methyl-ketone, and 1,8-cineol, as well as other ketones that are present in natural essential oils. The ketones listed in WO2004099352A are also well-suited.

The compound(s) of component F is/are selected from:
F1. one or more compounds comprising 10 carbon atoms and an hydroxyl functional group,
F2. one or more esters, the ester being an ester of a compound comprising 10 carbon atoms and an hydroxyl functional group, preferably an acetate or a propionate thereof,
or mixtures thereof.

Preferably the compound(s) of component F is/are selected from:
F1. terpineol, myrcenol, dihydro myrcenol, tetrahydro myrcenol, linalool, dihydro linalool, tetrahydro linalool, ocimenol,
F2. an ester of terpineol, myrcenol, dihydro myrcenol, tetrahydro myrcenol, linalool, dihydro linalool, tetrahydro linalool, and/or of ocimenol, preferably an acetate or a propionate thereof,
or mixtures thereof.

More preferably the compound(s) of component F is/are selected from:
F1. tetrahydro linalool,
F2. terpinyl acetate, myrcenol acetate, dihydro myrcenol acetate, tetrahydro myrcenol acetate, linalyl acetate, linalyl propionate, tetrahydro linalool acetate, ocimenol acetate,
or mixtures thereof.

Component G is optional. If present, it is different from component F. Well-suited as carbonic acid esters of optional component G are carbonic acid esters which may be represented by the formula:

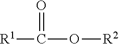

wherein R¹ and R² independently are hydrocarbyl groups of 1 to about 25 carbon atoms. In one embodiment, R¹ and R² independently contain from 1 to about 18 carbon atoms, and in one embodiment from 1 to about 12 carbon atoms, and in one embodiment from 1 to about 6 carbon atoms.

Examples of useful carboxylic acid esters include methyl acetate, ethylacetate, propylacetate, butyl acetate, n-pentyl acetate, amyl acetate, benzyl acetate, phenyl acetate, ethyl formate, ethyl acetate, ethyl propionate, ethyl butyrate, ethyl valerate, ethyl stearate, ethylphenyl acetate, ethyl benzoate, allyl caproate, amyl butyrate, benzylsalicylate, or a mixture of two or more thereof.

Preferably component G is chosen from: benzylsalicylate, amylbutyrate, ethylbutyrate, and amylacetate.

### Applications

The invention further relates to bitumen and crumb rubber modified bitumen compositions as obtained by the method of the invention.

The invention also relates to the use of bitumen and/or a crumb rubber modified bitumen composition as obtained by the invention in road surfacing and road base materials, in insulating layers for buildings, especially insulating layers against the penetration of water and moisture into buildings, in roofing materials such as roofing membranes, felts and shingles and/or in sealing sheeting. In all said applications, the bitumen and/or CRMB preferably is processed in liquefied form.

Bitumen and/or crumb rubber modified bitumen compositions prepared according to the method of the invention, optionally diluted with further bitumen, are suitably used to prepare asphalt mixtures that can be used in paving applications. Therefore, the invention further provides an asphalt mixture comprising a bitumen and/or CRMB composition according to the invention and further comprising aggregate. The aggregate may consist of filler, sand and/or stones.

### EXAMPLES

The invention will now be illustrated by the following example.

### Example 1

When processing liquid bitumen, or liquid crumb rubber modified bitumen, without admixing active agents and a diluting agent, a very strong smell was noticed. The odor can be compared to the odor of burnt tires.

The admixture of a mixture comprising 5 to 50 wt. % active agents and 95 to 50 wt. % of a diluting agent reduced the odor from liquid bitumen, and from liquid crumb rubber modified bitumen.

The addition of 0.14 gram mixture to 2 kg of bitumen or crumb rubber modified bitumen (i.e. 70 ppm) at a temperature of 185° C. decreased the odor.

The addition of 0.28 gram mixture to 2 kg of bitumen or crumb rubber modified bitumen (i.e. 140 ppm) at a temperature of 185° C. decreased the odor significantly.

The addition of 0.42 gram mixture to 2 kg of bitumen or crumb rubber modified bitumen (i.e. 210 ppm) at a temperature of 185° C. decreased the odor so much that the CRMB smelled like bitumen without crumb rubber.

The abovementioned active agents comprised linalyl acetate, being an acetate ester, of a compound comprising 10 carbon atoms and an hydroxyl functional group (i.e. linalool).

1. A method for reducing odors including the steps of admixing active agents and a diluting agent to liquid bitumen or to liquid crumb rubber modified bitumen wherein the active agents comprise:
A: 20 to 60 wt.-% of aldehyde(s) selected from:
A1. alpha-hexyl cinnamaldehyde,
A2. 2-(4-tert.-butylbenzyl) propionaldehyde,
A3. 2-benzylidenheptanal,
or mixtures thereof,
B: 0 to 20 wt.-% of one or more other aldehydes having at least 10 carbon atoms in the molecule,
C: 10 to 40 wt.-% of one or more alcohols having a boiling point of at least 150° C.,
D: 0 to 20 wt.-% of one or more terpenes having a boiling point of at least 150° C.,
E: 0 to 10 wt.-% of ketone(s) having a boiling point of at least 150° C.,
F: 0.3 to 1 wt % of compound(s) selected from:
F1. one or more compounds comprising 10 carbon atoms and an hydroxyl functional group,
F2. one or more esters, the ester being an ester of a compound comprising 10 carbon atoms and an hydroxyl functional group, preferably an acetate or a propionate thereof,
or mixtures thereof,
G: 0 to 10 wt.-% of carbonic acid ester(s), whereby the ester is different from component F;
calculated on the total weight of active agents.

2. The method according to claim 1, wherein component F is selected from:
F1. terpineol, myrcenol, dihydro myrcenol, tetrahydro myrcenol, linalool, dihydro linalool, tetrahydro linalool, ocimenol,
F2. an ester of terpineol, myrcenol, dihydro myrcenol, tetrahydro myrcenol, linalool, dihydro linalool, tetrahydro linalool, and/or of ocimenol, an acetate or a propionate thereof,
or mixtures thereof.

3. The method according to claim 2, wherein component F is selected from:
F1. tetrahydro linalool,
F2. terpinyl acetate, myrcenol acetate, dihydro myrcenol acetate, tetrahydro myrcenol acetate, linalyl acetate, linalyl propionate, tetrahydro linalool acetate, ocimenol acetate,
or mixtures thereof.

4. The method according to claim 1, wherein the diluting agent is a mineral oil, preferably a hydrocarbon middle distillate, or a vegetable oil, preferably sunflower oil, or a mixture thereof.

5. The method according to claim 1, wherein 10 to 200 ppm of a mixture of 5 to 50 wt.-% active agents and 95 to 50 wt.-% of a diluting agent is admixed with liquid bitumen,
the bitumen containing residues from crude oil distillation, or naturally occurring bitumen, or mixtures thereof,
whereby the bitumen optionally comprises a polymer, preferably a thermoplastic elastomer or plastomer, more preferably a styrene block copolymer and/or an olefin copolymer, even more preferably ethylene/vinylacetate copolymer.

6. The method according to claim 1, wherein 50 to 400 ppm of a mixture of 5 to 50 wt.-% active agents and 95 to 50 wt.-% of a diluting agent is admixed with a liquid crumb rubber modified bitumen composition comprising:
(a) 20 to 97 wt % bitumen;
(b) 3 to 80 wt % of crumb rubber;
calculated on the total weight of the crumb rubber modified bitumen composition.

7. The method according to claim 1, wherein 50 to 400 ppm of a mixture of 5 to 50 wt.-% active agents and 95 to 50 wt.-% of a diluting agent is admixed with a liquid crumb rubber modified bitumen composition comprising:
(a) 20 to 96 wt % bitumen;
(b) 3 to 80 wt % of crumb rubber;
(c) 0.1 to 10 wt % of a polymer comprising glycidyl functional groups; and
(d) 0.3 to 5 wt % of a wax;
wherein the weight percentages are based upon the weight of the crumb rubber modified bitumen composition.

8. The method of claim 1, wherein component B is selected from:
B1. 3-(4-iso-propylphenyl) 2-methylpropanal,
B2. 2-methylundecanal,
B3. 2-methyl-3-(3,4-methylene-dioxyphenyl)-propanal,
or mixtures thereof.

9. The method of claim 1, wherein component C is selected from:
C1. linalol,
C2. eugenol,
C3. geraniol,
C4. alpha-terpineol,
or mixtures thereof.

10. The method of claim 1, wherein component D is selected from:
D1. limonene,
D2. alpha-pinene,
or mixtures thereof.

11. The method of claim 1, wherein the polymer comprising glycidyl functional groups is a copolymer of ethylene and glycidyl acrylate or methacrylate, or a terpolymer of ethylene, alkyl acrylate or methacrylate and glycidyl acrylate or methacrylate.

12. The method of claim 1, wherein the polymer comprising glycidyl functional groups is a grafted polymer comprising glycidyl acrylate or methacrylate grafted onto a polyethylene backbone.

13. The method of claim 12, wherein the wax is a paraffin wax resulting from a Fischer-Tropsch process, or ethylene bis-stearamide.

14. The method of Bitumen or a crumb rubber modified bitumen composition as obtained by claim 1.

15. (canceled)
